(19) United States
(12) Patent Application Publication
(10) Pub. No.: US 2014/0129362 A1
(43) Pub. Date: May 8, 2014

(54) SYSTEMS AND METHODS FOR RESOLVING EXCEPTIONS DURING A RETAIL CHECKOUT

(71) Applicants: Craig Lewis Marquis, Floresville, TX (US); Ronald Andrew Wenzel, San Antonio, TX (US); Nhan Thanh Phan, San Antonio, TX (US); David Herschel May, Fair Oaks Ranch, TX (US)

(72) Inventors: Craig Lewis Marquis, Floresville, TX (US); Ronald Andrew Wenzel, San Antonio, TX (US); Nhan Thanh Phan, San Antonio, TX (US); David Herschel May, Fair Oaks Ranch, TX (US)

(21) Appl. No.: 13/669,181

(22) Filed: Nov. 5, 2012

(51) Int. Cl. G06Q 20/20

(52) U.S. Cl. 705/23

(57) ABSTRACT

Systems and methods for retail checkout and, more particularly, systems, methods, computer programs, and checkstands for managing and/or resolving exceptions generated using a multi-item identification device, are provided. In one embodiment, the method of performing retail checkout comprises: providing a multi-item identification device; collecting identification data regarding each of a plurality of items using the multi-item identification device; generating an active itemized order record that comprises information regarding each of the plurality of items using the identification data; recording at least one exception record in the active itemized order record relating to one or more of the plurality of items; providing a user with access to the active itemized order record; and using input from the user to resolve the exception record in the active itemized order record.

### BACKGROUND

The present disclosure generally relates to systems and methods for retail checkout and more particularly, to systems and methods for retail checkout using multi-item identification devices.

In many retail stores, such as supermarkets, checkout stands are equipped with scanning devices that optically scan product identification codes (e.g., bar codes) affixed to products being purchased by a customer. Additionally, some of these checkout stands may be configured to allow self-checkout, which permit a customer to self-scan their purchases in a substantially unattended manner. Self-checkout stands may be particularly desirable in view of their ability to reduce the number of store personnel dedicated to checkstands, thereby reducing labor costs.

A retail store generally has multiple standalone checkstands that are each configured to identify items in a customer's order, process coupons, accept payment, and/or perform other tasks to complete a customer's order. Most checkstands known in the art today comprise one or more computer terminals that are able to process information relating to purchased items and/or payment. While checkstand computer terminals generally communicate with centralized databases, for example, to obtain product information and/or to track inventory, they are designed or programmed to perform all tasks necessary to process a customer's order through completion locally (i.e., without intervention by or use of another computer system or server). Most checkstands also include a variety of electronic and/or mechanical components, such as conveyor belts, lights, etc., that can be manipulated to serve various functions and purposes. In most conventional checkstands, these elements are controlled manually by an attendant and/or by a control mechanism at the checkstand itself. Thus, conventional checkstands generally act as individual standalone systems. While this arrangement may have some benefits, the flexibility, functionality, and/or efficiency of such standalone checkstands may be limited.

While there are many different types of configurations for checkstands, one such configuration includes a conveyor which conveys items towards a multi-item scanner. One specific type of multi-item scanner is a “portal” or “tunnel” scanner that is capable of identifying an item by taking an image of the item as it passes through and/or scanning the image of a bar code located on the item.

While the use of a multi-item scanner in conjunction with retail checkout is beneficial for many reasons, including increased efficiency and faster checkout times, it is not uncommon for one or more exceptions to occur while using a multi-item scanner to itemize a customer's order. An “exception” may include any instance in which an item is detected at the checkstand but is flagged for further action or review before adding it to the customer's order. Indeed, exceptions may occur in a variety of circumstances, including those situations where a scanner encounters defective or invalid information, or in response to identifying a particular type of item. For example, an exception can be generated when an item is mis-scanned, is not properly identified, requires age-verification for purchase, exceeds a pre-determined limit of items, may not be purchased at that time, etc. An exception also may be generated when multiple items and/or bar codes are identified simultaneously.

The current method used in most retail stores for resolving exceptions is for special intervention by store personnel at the specific checkstand at which the exception is generated. In addition, exceptions must typically either be resolved immediately as they are encountered, thereby prohibiting a customer from adding additional items to their order until the exception is resolved, or resolved only after all items have been scanned and added to an order. However, these current methods for resolving exceptions are generally counter-productive to the overall goal of checkout methods, which is to decrease requirements on the time of store personnel and provide for faster checkout times.

Furthermore, while the use of a multi-item scanner in checkstands may provide increased efficiency and speed, in certain instances it may result in certain improprieties in an order. For example, if too many items are passed through the multi-item scanner simultaneously, then the scanner may fail to itemize all of the items, thereby resulting in a loss for the retail store.

Therefore, what is needed are systems and methods that may provide increased efficiency at checkstands, including reducing or eliminating the amount of time required to resolve exceptions with a customer's order, and/or increased accuracy of itemization of a customer's order while using a multi-item scanner at checkstands.

### SUMMARY

The present disclosure generally relates to systems and methods for retail checkout and more particularly, to systems and methods for retail checkout using multi-item identification devices.

In one embodiment, the present invention provides a method of performing retail checkout comprising: providing a multi-item identification device; collecting identification data regarding each of a plurality of items using the multi-item identification device; generating an active itemized order record that comprises information regarding each of the plurality of items using the identification data; recording at least one exception record in the active itemized order record relating to one or more of the plurality of items; providing a user with access to the active itemized order record; and using input from the user to resolve the exception record in the active itemized order record.

In another embodiment, the present invention provides a method of performing retail checkout comprising: providing a multi-item identification device; collecting identification data regarding each of a plurality of items using the multi-item identification device; generating an active itemized order record that comprises information regarding each of the plurality of items using the identification data; recording at least one exception record in the active itemized order record relating to one or more of the plurality of items; suspending the active itemized order record at a first terminal to generate a suspended itemized order record comprising at least one exception record; providing a user with access to the suspended itemized order record; and using input from the user to resolve the exception record in the suspended itemized order record.

In another embodiment, the present invention provides a computer program stored in a tangible medium for performing a retail checkout process comprising a plurality of instructions that when executed cause at least one processor to: receive identification data regarding each of a plurality of items from a multi-item identification device; generate an active itemized order record that comprises information regarding each of the plurality of items using the identification data; record at least one exception record in the active itemized order record relating to one or more of the plurality of items; provide an active itemized order record to a user; and receive input from the user to resolve the exception record in the active itemized order record.

In another embodiment, the present invention provides a method of performing retail checkout comprising: providing a multi-item identification device; scanning or imaging each of a plurality of items using the multi-item identification device, wherein two or more of the plurality of items are scanned or imaged substantially simultaneously; generating an active itemized order record that comprises information regarding each of the plurality of items; and recording at least one exception record in the active itemized order record relating to the items that are scanned or imaged substantially simultaneously if the number of items scanned or imaged by the multi-item identification device substantially simultaneously exceeds a pre-determined threshhold value.

In another embodiment, the present invention provides a retail checkout system comprising: one or more checkstands that each comprise a multi-item identification device configured to collect identification data regarding items in a customer's order, and an interface unit configured to transmit data to a data server based at least in part on the item identification data collected by the multi-item identification device; and a data server that comprises at least one processor, an interface unit configured to receive data from one or more checkstands, and a memory comprising executable instructions that, when executed, cause the at least one processor to: generate itemized order records that comprise information regarding the items in a customer's order, record exception records in an itemized order record relating to one or more items in the customer's order, and resolve an exception record in an itemized order record in response to input from a user.

The features and advantages of the present invention will be apparent to those skilled in the art. While numerous changes may be made by those skilled in the art, such changes are within the spirit of the invention.

### DRAWINGS

Some specific example embodiments of the disclosure may be understood by referring, in part, to the following description and the accompanying drawings.

FIG. 1 depicts a checkstand for use in a retail store, according to one embodiment of the present disclosure.

FIG. 2 depicts a retail checkout system according to one embodiment of the present disclosure.

FIG. 3 is a flowchart that depicts a portion of a retail checkout process according to one embodiment of the present disclosure.

FIG. 4 is a flowchart that depicts another portion of a retail checkout process according to one embodiment of the present disclosure.

FIG. 5 is a flowchart that depicts a process for controlling certain components of a checkout system according to one embodiment of the present disclosure.

FIG. 6 is a flowchart that depicts a process for managing retail checkout exceptions in one embodiment of the present disclosure.

FIG. 7 is a flowchart that depicts another process for managing retail checkout exceptions in one embodiment of the present disclosure.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure generally relates to systems and methods for retail checkout and more particularly, to systems and methods for retail checkout using multi-item identification devices. One of the many advantages of the present disclosure is that the systems and methods disclosed herein may provide increased efficiency and/or accuracy at checkstands.

More particularly, the present disclosure provides systems and methods for retail checkout using multi-item identification devices, such as multi-item scanners. In one embodiment, the present disclosure provides methods for controlling multiple checkstands (and the various components thereof) incorporating multi-item identification devices at checkstands that are operatively connected to a centralized point-of-sale data server. In these embodiments, the point-of-sale server may perform many of the computerized processes involved in processing a customer's order and/or control various electronic and/or mechanical components at the checkstand(s). This may, among other things, enhance the flexibility, functionality, and/or efficiency of checkout systems and checkstands at a retail store.

In another embodiment, the present disclosure provides systems and methods for managing and/or resolving exceptions in an order generated using a multi-item identification device. For example, certain embodiments of the present disclosure provide methods of resolving exceptions in real time, while still allowing the customer to add additional items to their order. In other embodiments, the present disclosure provides systems and methods for resolving exceptions that involve multiple items or barcodes that are scanned simultaneously.

While it should be appreciated that the systems and methods disclosed herein may be used in conjunction with any suitable checkout system of any configuration, they may be particularly useful in those checkout systems that comprise a multi-item identification device. In general, multi-item identification devices suitable for use in the present disclosure are those devices that are designed to identify more than one item substantially simultaneously and that comprise at least (a) one or more devices for scanning or imaging an item and/or a product identification code present on an item, (b) a processing device for collecting and outputting identification data relating to item's identity based on the scanned code or image, and (c) software capable of directing the performance of tasks necessary to operate the multi-item identification device.

One example of a multi-item identification device suitable for use in the present invention is a multi-item scanner. As will be recognized by one of skill in the art, a variety of multi-item scanners may be suitable for use in the present disclosure, including those multi-item scanners commonly referred to as “portal” or “tunnel” scanners. One example of a particularly suitable multi-item scanner is a X7 model scanner available from Datalogic. Furthermore, while the descriptions contained in this disclosure generally refer to an item being “scanned” by a multi-item scanner, it should be understood that this term is intended to encompass not only the optical scanning of a product identification code (e.g., bar code) present on an item, but also includes taking an image of an item or taking an image of a product identification code located on the item.

Other multi-item identification devices that may be suitable for use in the present invention may include devices that identify items by collecting data regarding the physical characteristics of an item (e.g., size, shape, color, and/or volume) and correlating that data with an indexed database that matches those characteristics to specific items. A person of skill in the art with the benefit of this disclosure will recognize these and other types of multi-item identification devices available in the art and how they may be incorporated into the methods and systems of the present invention.

1. Components of the Checkout System

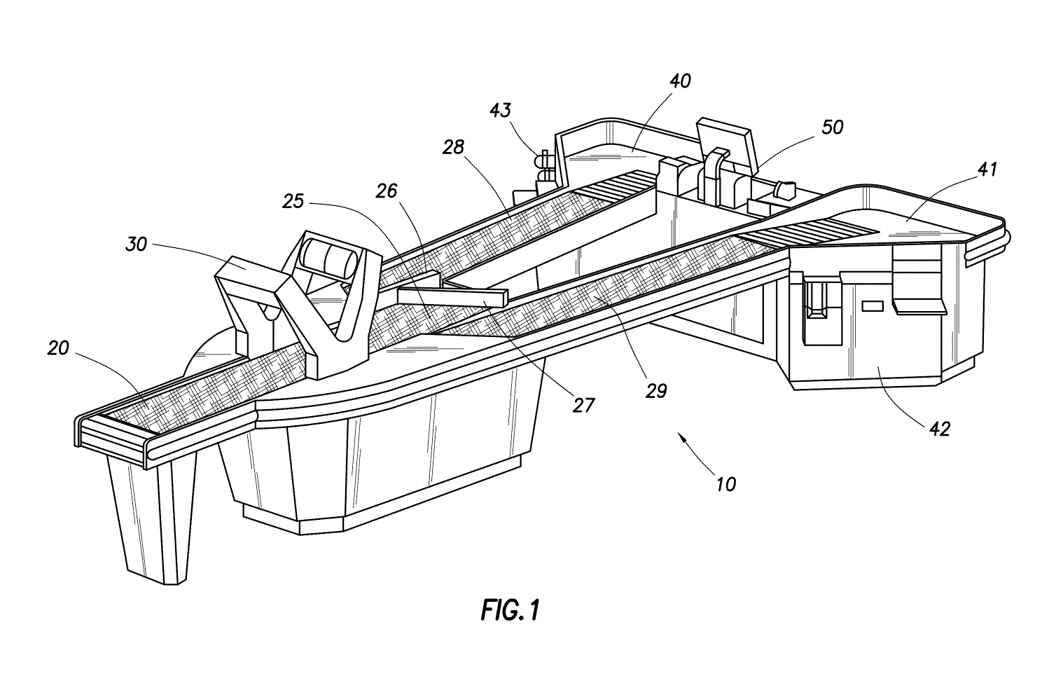

In one embodiment, the present disclosure provides a retail checkout system comprising a plurality of checkstands for use for use in a retail store, such as a supermarket, and a point of sale (“POS”) data server that communicates with various electronic components at each of the plurality of checkstands. While there are various known and suitable checkstand configurations, a particularly suitable configuration for a checkstand of the present disclosure generally comprises a multi-item identification device and one or more conveyors. In some embodiments, the checkstand may further comprise one or more collection or bagwell areas, one or more computer terminals, one or more theft mitigation devices, and may also include other components commonly associated with checkstands and checkout systems. An example of one configuration for a suitable checkstand is depicted in FIG. 1 and will be discussed in further detail below.

The retail checkout systems of the present disclosure generally incorporate one or more computer terminals that can be operated by a user (which includes store personnel, customers, or both) in order to perform various functions in the retail checkout system. As will be recognized by one of skill in the art, the retail computer terminals suitable for use in the present disclosure may be used to perform various functions, including but not limited to itemization of orders, resolution of exceptions, processing of payment, and/or a combination thereof. Itemization terminals generally include the components necessary to allow a customer to itemize their items for purchase within an order and thereafter generate indicia such as a paper or electronic payment ticket which may be utilized to tender payment for their order at another location, such as a payment terminal. Exception-resolution terminals generally include the components necessary to resolve exceptions within a customer's order. Payment terminals generally include the components necessary to allow a customer to tender payment for their order. Some terminals may be capable of performing two or more of exception resolution, payment, and/or itemization. The “terminals” described in the present disclosure generally comprise at least one processor and an interface unit configured to transmit data to and receive data from other computer systems or devices. The processor may comprise any microprocessor, central processing unit (“CPU”), or other computer processors known in the art, and the interface unit may comprise any type of computer interface device known or used in the art with electronics and computer systems, including but not limited to modems, Ethernet/wi-fi/LAN adapters, serial connections, and other similar types of devices. However, the “terminals” of the present disclosure do not require any particular configuration, and are not limited to “desktop” computers or large or stationary computer systems. Examples of suitable computer terminals may include desktop and/or laptop computer terminals available from various suppliers and manufacturers or handheld devices, such as cellular phones, tablet computers, or other portable computer devices. Examples of suitable types of computer terminals are known to those of skill in the art and, with the benefit of this disclosure, can be incorporated into the methods and systems of the present invention.

Referring now to FIG. 1, in a typical mode of operation, a customer may bring the items they desire to purchase to a checkstand 10 and place the items on an intake conveyor 20 (e.g., a conveyor belt) that moves the items toward a multi-item identification device 30 positioned at the end of intake conveyor 20. The items are then scanned and/or imaged by the multi-item identification device 30 and subsequently moved onto a transition conveyor 25, a first end of which is arranged adjacent to the end of intake conveyor 20 near the multi-item identification device 30. The speeds of intake conveyor 20 and transition conveyor 25 may vary depending on, among other things, the rate of items being loaded and passed through the multi-item identification device 30. Intake conveyor 20 and transition conveyor 25 may operate at the same speed or at different speeds. A person of skill in the art, with the benefit of this disclosure, will recognize the appropriate speeds for intake conveyor 20 and transition conveyor 25 in a particular application of the present invention. In some embodiments, the first end of the transition conveyor 25 may be arranged so as to leave a gap or space between that end and the end of the intake conveyor 20. This may facilitate scanning of product identification codes located on the bottom of an item. The gap or space should be of a size sufficient to allows scanning of a product identification code passing over the gap but should not be large enough to allow items to fall through the gap. The size of the gap or space may depend upon, among other things, the type of multi-item identification device incorporated in the checkstand, and the manufacturer of the multi-item identification device may provide specifications for the location and/or size of the gap desirable in the use of their particular multi-item identification device.

The checkstand 10 shown in FIG. 1 also includes two outtake conveyors 28 and 29 having a first end arranged to receive items from the transition conveyor 25. Collection areas 40 and 41 are arranged adjacent to the other ends of outtake conveyors 28 and 29 to receive items from its respective outtake conveyor. The speed(s) of outtake conveyors 28 and 29 may vary depending on, among other things, the rate of items being loaded and passed through the multi-item identification device 30 and/or the speed of intake conveyor 20 or transition conveyor 25. Outtake conveyors 28 and 29 may operate at the same speed or at different speeds. A person of skill in the art, with the benefit of this disclosure, will recognize the appropriate speeds for outtake conveyors 28 and 29 in a particular application of the present invention. In this embodiment, a first customer may itemize his order using the multi-item identification device 30 and his items can be moved onto outtake conveyor 28 and collection area 40 for bagging while the first customer's order is processed and completed and/or his items are bagged. During that time, a second customer may bring items that they desire to purchase to the same checkstand 10. Diverter arms 26 and 27 may be positioned near the end of transition conveyor 25 near the outtake conveyors 28 and 29 so as to prevent the second customer's items from passing to outtake conveyor 28 and direct those items to outtake conveyor 29 and collection area 41. This arrangement may increase the efficiency of the checkout process, reduce the amount of space and/or equipment required for a checkout system of the present disclosure, and/or provide other benefits. As a person of skill in the art will recognize, the methods and systems of the present disclosure could be practiced with checkstands having only a single outtake conveyor and/or collection area for a particular multi-item identification device, or with checkstands having more than two collection areas for a particular multi-item identification device.

Checkstand 10 also includes customer interaction stations 42 and 43 corresponding to each of collection areas 40 and 41 at which a customer may monitor and await the completion of his order. Customer interaction stations may include a customer terminal (not shown) and/or a display monitor at which a customer may, among other things, monitor the status of their order, view advertising, add unscanned items to their order, provide input used to process their order, resolve exceptions, and/or tender payment for an order. The customer interaction station may be of any size, location, and/or configuration suitable for a particular use of the present disclosure, and may be altered from the embodiment shown, for example, in order to enhance usage of space, efficiency of use, convenience of the user, and/or several other factors that will be apparent to a person of skill in the art in view of this disclosure.

Checkstand 10 also includes an attendant station 50 that includes an attendant terminal 151 at which an attendant or other store personnel may, among other things, monitor the status of one or more orders, add or remove items on orders, provide input used to process orders, resolve exceptions, tender payment for orders, and/or control other electronic and/or mechanical components of the checkstands. The attendant station may be of any size, location, and/or configuration suitable for a particular use of the present disclosure, and may be altered from the embodiment shown, for example, in order to enhance usage of space, efficiency of use, convenience of the user, and/or several other factors that will be apparent to a person of skill in the art in view of this disclosure.

Examples of suitable computer terminals for the customer terminal and/or attendant terminal 151 may include desktop computer terminals, laptop computer terminals, and/or “thin client” computer terminals available from various suppliers and manufacturers (e.g., Dell, HP, etc.). In some embodiments, the customer terminal and/or attendant terminal may comprise handheld devices, such as cellular phones, tablet computers, or other portable computer devices. Examples of suitable types of computer terminals are known to those of skill in the art and, with the benefit of this disclosure, can be incorporated into the methods and systems of the present invention. The customer and attendant terminals may include, incorporate, or interface with various types of input and output devices. Suitable output devices may include, but are not limited to, display monitors, audio speakers, printers, and/or cash/coin acceptors or dispensers. Suitable input devices may include, but are not limited to, touch screens, mouses, keyboards, additional scanning devices (e.g., handheld scanners), payment devices (e.g., credit card readers, cash/coin acceptors) and the like. Suitable input and output devices (and combinations thereof) for terminals 141 and 151 in a particular embodiment of the present invention may vary depending upon convenience to the user, efficiency of use, and/or several other factors that will be apparent to a person of skill in the art in view of this disclosure.

During scanning and/or imaging, information relating to each item that is passed through the multi-item identification device is received by the POS server and the details of each item are added to a corresponding order, along with any exceptions. As previously mentioned, it is not uncommon for one or more exceptions to be generated during the itemization of a customer's order. For example, an exception may be generated where the multi-item identification device encounters defective or invalid information, or in response to the scanning of a particular type of item. In certain specific embodiments, an excepted item may be identified by associating an image of the item with the exception. In other embodiments, an excepted item may be identified using other components in the checkout system, such as indicator lights along the outtake conveyor or the like.

In some embodiments of the present disclosure, an end-of-order divider (not shown) may be placed on the intake conveyor after the last item of a customer's order. The end-of-order divider may include a scannable identification code such as a barcode or emit a signal that allows the multi-item identification device to identify it as such. The detection of an end-of-order divider may be used to trigger one or more actions in the checkout system, for example, the movement of the diverter arms 26 or 27 to direct subsequently-scanned items to a different collection area, prompting the customer (via a customer terminal, display, or other output device) to provide payment or other input needed to complete the order, and the like.

2. Checkout System Architecture and Process

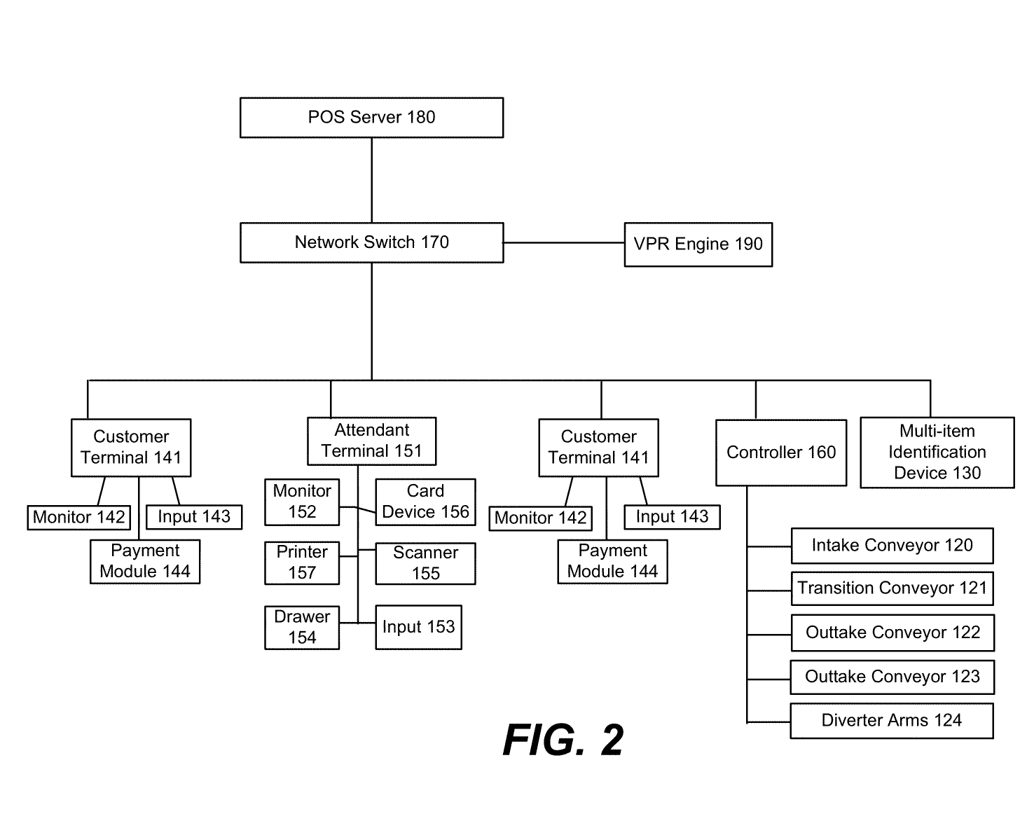

An embodiment of the retail checkout system of the present disclosure is illustrated in FIG. 2. The system includes a multi-item identification device 130, a visual pattern recognition (VPR) engine 190, one or more customer terminals 141 (each of which may be located at a customer interaction station), a controller 160, a network switch 170, an attendant terminal 151 (which may be located at an attendant station), and a POS server 180. The customer terminals 141 and attendant terminal 151 may comprise any known type of computer terminal.

Retail checkout systems of the present disclosure may comprise a centralized point-of-sale (POS) data server that communicates with various components (e.g., computer terminals, scanners, controllers, etc.) at a plurality of checkstands. The POS server receives data from certain components at each checkstand, including information for each item scanned or imaged by the multi-item identification device. The POS server creates and maintains itemized order records that include information regarding scanned items, exceptions, and the like pertaining to the customer's transaction. The POS data servers used in the systems of the present disclosure generally comprise at least one processor, a memory that may comprise executable instructions for the processor, an interface unit configured to transmit data to and receive data from other computer systems or devices. The processor may comprise any microprocessor, central processing unit (“CPU”), or other computer processors known in the art, and the interface unit may comprise any type of computer interface device known or used in the art with electronics and computer systems, including but not limited to modems, Ethernet/wi-fi/LAN adapters, serial connections, and other similar types of devices. The processor may include an internal memory device and/or be configured to access a separate memory device or drive comprising executable instructions. POS data servers suitable for use in the present disclosure include those commercially available from Dell, IBM, and Apple. The POS server also may include multiple redundant servers that operate as mirrors of each other, which may, among other purposes, increase speed of the system and/or help compensate for failures or other problems in the servers. The POS server may be located on-site at the same retail store where the associated checkstands are located, or it may be located at a separate location from the retail store. In some embodiments, the POS server may communicate with checkstands and other components at a single retail store. In other embodiments, the POS server may communicate with checkstands and/or other components at multiple retail stores.

The various components at a particular checkstand (i.e., the multi-item identification device 130, terminals 141 and 151, and the controller 160) are each connected to a network switch 170 at the checkstand. The network switch 170 may comprise any known network switch or switching hub, several commercial embodiments of which are available from various suppliers and manufacturers. Network switch 170 is also operatively connected to the POS server 180 (e.g., through a network switch stack (not shown)).

The multi-item identification device 130 may comprise a multi-item scanner as described herein. In the embodiment shown in FIG. 2, a single multi-item identification device is configured to scan items for orders that are then assigned to one of multiple customer terminals 141. In this embodiment, multi-item identification device 130 may be operatively connected to a proxy (not shown) that selectively indicates the order with which the scanned items (or exceptions) are associated. The POS server also communicates with VPR engine 190, which interprets and processes images provided by multi-item identification device 130. In some embodiments, the VPR engine 190 may be on a separate server at the store or on a server in a remote location (i.e., not on-site at the retail store).

The customer terminals 141 are operatively connected to the switch 170. Customer terminals 141 display information regarding items scanned or identified at multi-item identification device 130 (if those items are designated for that customer terminal). Customer terminals 141 also receive and send input from customers to the POS server 180. Customer terminals 141 also receive information and instructions from the POS server 180 that are used to process and complete the customer's order. In the embodiment shown in FIG. 2, customer terminals 141 are each connected to a display monitor 142, an input device 143 (e.g., a keyboard, mouse, or touch-screen device), and a self-serve payment module 144 (e.g., an iCASH module).

An attendant terminal 151 is operatively connected to the switch 170. A store employee may perform operations or provide input (e.g., resolve exceptions) at attendant terminal 151, which sends information to the POS server 180. The POS server 180 may use that in processing an order and/or to control electronic and/or mechanical components of the system connected to controller 160. Attendant terminal 151 also may receive information and instructions from the POS server 180 that may be used to process and complete the customer's order. In the embodiment shown in FIG. 2, attendant terminals 151 is connected to a display monitor 152, an input device 153 (e.g., a keyboard, mouse, or touch-screen device), a cash drawer 154, a scanning device 155, a credit/debit card payment device 156, and a receipt printer 157.

The controller 160 is operatively connected to the switch 170 and to the control mechanisms for an intake conveyor (120), a transition conveyor (121), two outtake conveyors (122 and 123), and diverter arms (124). The controller may comprise any type of programmable controller or programmable logic controller known in the art that is capable of providing output signals to one or more electronic and/or mechanical components in response to input signals from the POS server. In some embodiments, controller 160 also may be connected to other electronic and/or mechanical components in the retail checkout system, such as lights, monitors, barriers, and the like. The POS server 180 sends signals (either automatically or in response to input received at terminals 141 or 151) to the controller 160 in order to control the motion and/or status of the conveyors, divider, and/or other components associated with the controller 160. The electronic and/or mechanical components associated with controller 160 also may send information regarding the motion and/or status of the conveyors, divider, and/or other components to the POS server 180 so that the POS server 180 can use that information in performing various processes in the system. In the embodiment shown in FIG. 2, a separate controller device is operatively connected to several different electronic and/or mechanical components at a checkstand. Of course, in some embodiments, an electronic and/or mechanical component may comprise its own built-in controller device that is connected to a network switch.

In certain embodiments, the checkout systems of the present invention may comprise additional terminals and/or displays operatively connected to the POS server that are configured to perform certain functions. For example, the checkout systems of the present invention may comprise separate terminals (for customer and/or store personnel use) reserved for resolving exceptions in customer orders. In another embodiment, the checkout systems of the present invention may comprise separate terminals (for customer and/or store personnel use) reserved for processing payment of certain types. Certain of these “payment only” terminals may be designated and/or configured to receive on specific types of payment (e.g., cash only, credit card only, etc.). In another embodiment, if the POS server receives input (e.g., signals from sensors, user input, etc.) that one or more item collection areas at certain checkstands are empty, the POS server may record that information for each checkstand and display it on a display monitor operatively connected to the POS server to communicate to customers and/or store personnel which checkstands are available for use. In another embodiment, the checkout systems of the present invention may comprise additional terminals through which store personnel or other designated personnel may monitor activity in the checkout system. This may, among other benefits, allow businesses to more efficiently evaluate and monitor the status of checkout systems of the present invention and/or resolve problems that occur at a particular checkstand.

These additional terminals and/or displays are operatively connected to the POS server via a network switch or some other network communications device, but may be positioned anywhere in the store, at a remote location, or carried by a customer or store personnel. In some embodiments, these additional terminals may comprise handheld electronics devices carried by a customer, such as a cellphone, a tablet computer device, or the like.

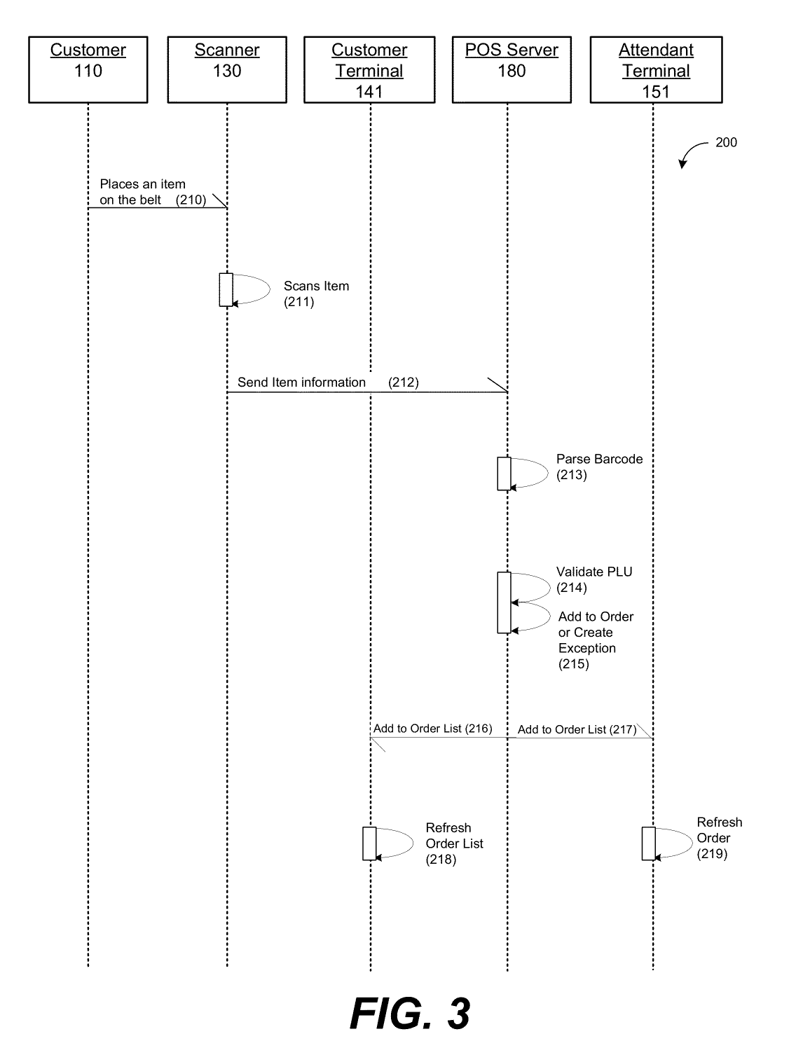

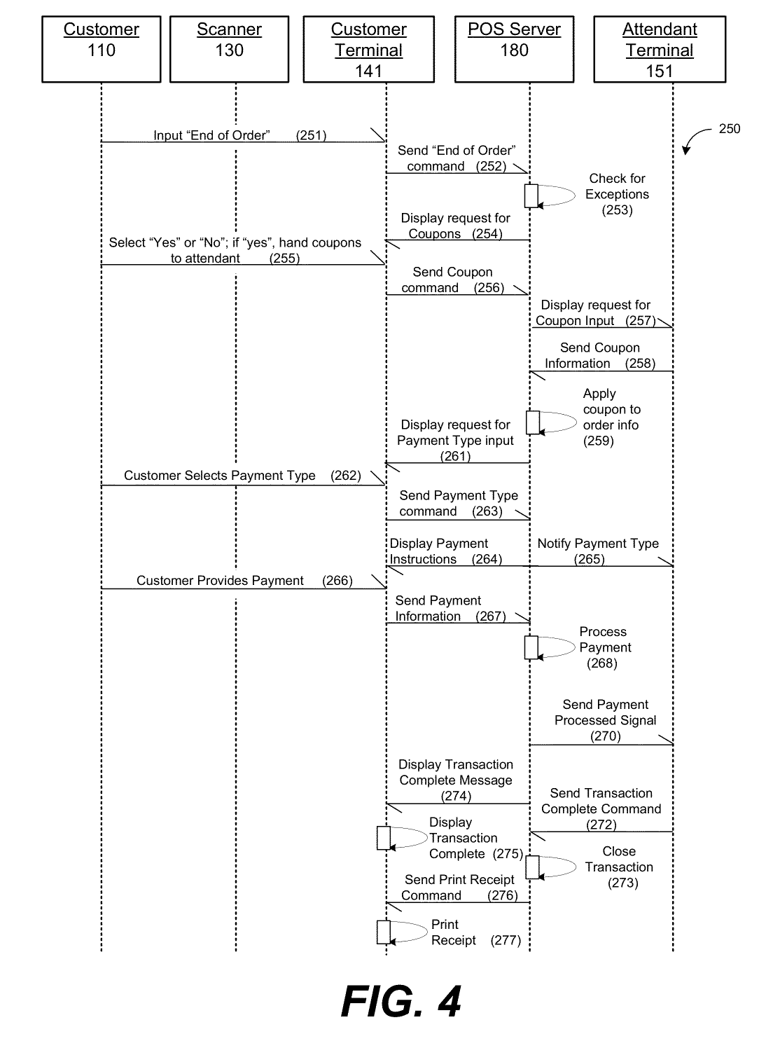

An embodiment of a process 200 and 250 for processing an order in one embodiment of the present invention is shown in FIGS. 3 and 4. Referring to FIG. 3, the customer places an item on the intake conveyor (210) and the multi-item identification device 130 scans the item (211). The multi-item identification device sends the item information obtained (e.g., barcode, image of item) to the POS server 180 (212), including information regarding any exceptions created by the multi-item identification device (e.g., item without a barcode detected). Any exceptions created by the multi-item identification device are added to an itemized order record that is created on the POS server 180 for that particular order. If a barcode is detected, the POS server parses the barcode (213) and validates the PLU associated with that barcode (214). At step 215, the POS server will record an exception in the itemized order record if the PLU is programmed to do so; if no exception is programmed for the particular PLU, the item is recorded in the itemized order record. The POS server sends a command to the customer terminal 141 and attendant terminal 151 to add the item to the order list (216 and 217). The customer terminal 141 and attendant terminal 151 then refresh the order list on their displays to show the new item (218 and 219). This process 200 is repeated for each item in the customer's order.

Referring now to FIG. 4, process 250 may be performed after process 200 once all of his items have been placed on the intake conveyor. In this embodiment, the customer inputs an “End of Order” command once all of his items have been passed through the multi-item identification device (251). This may be accomplished in any number of ways, including but not limited to pressing a button at a customer terminal, as shown in FIG. 4. In another embodiment, the “End of Order” command may be made by placing an end-of-order divider on the intake belt that is subsequently identified and/or scanned by the multi-item identification device. In yet another embodiment, an attendant or other store personnel may input the “End of Order” command for a particular customer's order, for example, by pressing a button at the attendant terminal 150. In the embodiment shown in FIG. 4, the customer terminal 141 sends the “End of Order command to the POS server 180 (252). In response to that command, the POS server 180 checks the customer's order for the presence of any exceptions (253). If any exceptions are present, the POS server 180 may send one or more signals to the customer and/or attendant terminals to prompt resolution of the exceptions as discussed below, and in some embodiments, may require that all exceptions be resolved before the order can be completed.

Next, the POS server sends a signal to the customer terminal 141 to display a request to state whether the customer has any coupons (254). The customer selects a “Yes” or “No” option at the customer terminal 141 (255) and hands any coupons to the attendant. The customer terminal 141 sends a coupon command to the POS server 180 (256) that reflects the customer's input in step 255. If the customer selected “Yes”, the POS server will send a signal to the attendant terminal 151 to display a request for coupon information (257). An attendant will input the coupon information at the attendant terminal 151, and that information will be sent to the POS server (258) and applied to the order (259). Next, the POS server 180 will send a signal to the customer terminal 141 to display a request for the type of payment that the customer would like to use (261), which may include various pre-set options for the customer to choose from. The customer selects a payment option at the customer terminal 141 (262), and the customer terminal sends a payment type command to the POS server 180 (263) that reflects the customer's input in step 262. The POS server 180 then sends a signal to the customer terminal 141 to display payment instructions (264) based on the type of payment that the customer selected in step 262. The POS server 180 also sends a signal to the attendant terminal 151 to notify the attendant of the payment type (265) based on the type of payment that the customer selected in step 262.

The checkstands and checkout systems of the present invention may be configured to accept various forms of payment at the customer terminal, the attendant terminal, and/or some other terminal or device. For example, a checkout system of the present invention may be configured to accept cash at only the attendant terminal. In other embodiments, the checkstand or another terminal in the store may be equipped with a device that is capable of accepting cash payments from a customer without attendant intervention (e.g., iCash terminals).

In other embodiments, a checkout system of the present invention may be configured to process and/or authorize payment from a credit card account, checking account, and/or other payment account from the customer terminal, the attendant terminal, or another device, such a cellphone or other personal electronic device that communicates with the POS server.

In the embodiments shown in FIG. 4, the customer provides and/or authorizes payment at customer terminal 141 (266), and the customer terminal 141 sends that payment information to the POS server 180 (267). The POS server applies the payment information from step 267 to the customer's order (268). In the process shown in FIG. 4, the POS server sends a signal to the attendant terminal 151 indicating that the customer's payment has been processed (270). The attendant views this information and, if the customer is ready to complete his order, the attendant provides input at the attendant terminal 151 that the order is complete (not shown), which the attendant terminal 151 sends to the POS server 180 (272). In response to this input, the POS server 180 closes the transaction (273). Of course, in other embodiments of the present invention, a POS server may be configured to close the transaction in response to input by the customer, or without further intervention or input from a customer or attendant once the payment due on a particular order is equal to zero. Once the transaction has been closed, the POS server 180 sends commands to the customer terminal 141 to display a message that the transaction is complete (274) and to print a receipt for the order (276). The customer terminal 141 performs these tasks (275 and 277).

3. Control of System Components

In another embodiment, the checkout systems of the present invention may be capable of controlling various electronic and/or mechanical components at one or more checkstands through the POS server that perform certain predetermined (e.g., programmed) actions. Examples of electronic and/or mechanical components that may be controlled in this manner include, but are not limited to, conveyors (e.g., conveyor belts), diverter arms, lights, audio and/or display devices, monitors, barriers, and the like. For example, the movement and/or speed of the various conveyors (e.g., intake conveyor, transition conveyor, and/or outtake conveyor) may be controlled through the POS server in response to certain events (e.g., conditions detected, customer/attendant/input, etc.) occurring in the system.

In some embodiments, one or more sensor devices may be positioned at various locations in the checkout system to detect the presence of certain items or events in the system. Sensor devices suitable for use in the present invention may comprise any type of sensor known in the art, including but not limited to optical sensors, infrared sensors, motion sensors, heat sensors, weight sensors, cameras, and the like. Alternatively, the sensor device may comprise a camera that is capable of detecting motion or the presence of an item. A person of skill in the art will recognize the type(s) of sensing devices that may be suitable for a particular application of the present invention. These sensor devices may be operatively connected to the POS server (for example, via a network switch) to send signals to the POS server regarding the items or events that they detect. The POS server may be configured to perform various functions (e.g., control other components of a checkstand and/or start other steps in the checkout process) in response to those signals without intervention by a customer or store personnel. For example, referring to FIG. 1, a sensor device (not shown) may be positioned along the intake conveyor 20 to detect items loaded on it that are ready to be scanned. In another embodiment, one or more sensor devices (not shown) may be positioned at the end of outtake conveyor 28 or 29 near the collection areas 40 and 41 or elsewhere in collection areas 40 and 41 in order to detect the presence of items that have been scanned and/or bagged. In another embodiment, one or more sensor devices may be positioned along the transition conveyor 25 and/or at the end of outtake conveyor 28 or 29 near the transition conveyor 25. If an item is detected at this location for longer than a predetermined period of time (e.g., 5-10 seconds), this may indicate a backlog of items at that location.

Referring to FIG. 1, in some embodiments, one or more of the conveyors 20, 25, 28, and/or 29 may remain stationary when the checkstand is not in use. Referring now to FIG. 2, the POS server 180 may send a signal to the controller 160 to start the motion of one or more of conveyors 120, 121, 122, and/or 123 in response to, for example, input by an attendant or a signal from a sensor detecting items placed on the intake conveyor. In another embodiment, the POS server 180 may send a signal to the controller 160 to stop the motion of one or more of conveyors 120, 121, 122, and/or 123 in response to, for example, input by an attendant, an absence of signal from a sensor detecting items placed on the intake conveyor for longer than a predetermined period of time (e.g., 20-30 seconds), or the scanning of an end-of-order divider after the last item of a customer's order.

In another embodiment, the POS server 180 may send a signal to the controller 160 to stop the motion of one or more of conveyors 120, 121, 122, and/or 123 in response to certain input by an attendant or a signal from a sensor in the checkout system. For example, a sensor (not shown) positioned along the transition conveyor and/or outtake conveyor or in a collection area detecting the uninterrupted presence of an item for longer than a predetermined period of time (e.g., 5-10 seconds) may indicate, for example, a backlog of items or that collection areas have reached the capacity of items that they can hold. In response to such a signal from a sensor, the POS server 180 may send a signal to the controller 160 to stop the motion of one or more of conveyors 120, 121, 122, and/or 123. Once the sensor detects that items have been removed from the conveyors and/or collection area, the sensor may send a signal to the POS server 180 indicating that the items are gone, and the POS server 180 may send a signal to the controller 160 to re-start the motion of one or more of conveyors 120, 121, 122, and/or 123. This process also may be used to facilitate the separation of different customer's orders at a single checkstand. For example, referring now to FIG. 1, a new customer may load items onto intake conveyor 20 for scanning while prior customers' items are still present (as detected by a sensor device) in collection areas 40 and 41. Referring now to FIG. 2, in these embodiments, the POS server 180 may send a signal to controller 160 to stop the motion of intake conveyor 120. Once the POS server 180 receives a signal from a sensor device (not shown) indicating that items have been removed from one of the collection areas at that checkstand, the POS server 180 may send a signal to the controller 180 to re-start the motion of intake conveyor 120.

In another embodiment, the POS server may send a signal to the controller to vary the speed of one or more of the conveyors on a particular checkstand. For example, if the POS server receives a signal or input that a store attendant (as opposed to a customer) is loading and/or bagging items at a particular checkstand, the POS server may send a signal to the controller at that particular checkstand that causes one or more of the conveyors to operate at a higher speed than if a customer was loading and/or bagging items. In other embodiments, the POS server may be configured to vary the speed of one or more conveyors in the system during the itemization of a particular customer's order. For example, if the multi-item identification device is detecting too many items passing through it at the same time or in a given amount of space on the conveyor, the POS server may send a signal to the controller to increase the speed of the intake conveyor, among other reasons, to increase the separation between items as they are loaded onto the intake conveyor and passed through the multi-item identification device. In another embodiment, the POS server may send a signal to the controller to increase the speed of the transition conveyor and/or outtake conveyor(s) in response to an increased number of items passing through the multi-item identification device, among other purposes, in order to pass items to the collection areas more quickly and thereby prevent or reduce a backlog of items along the conveyors.

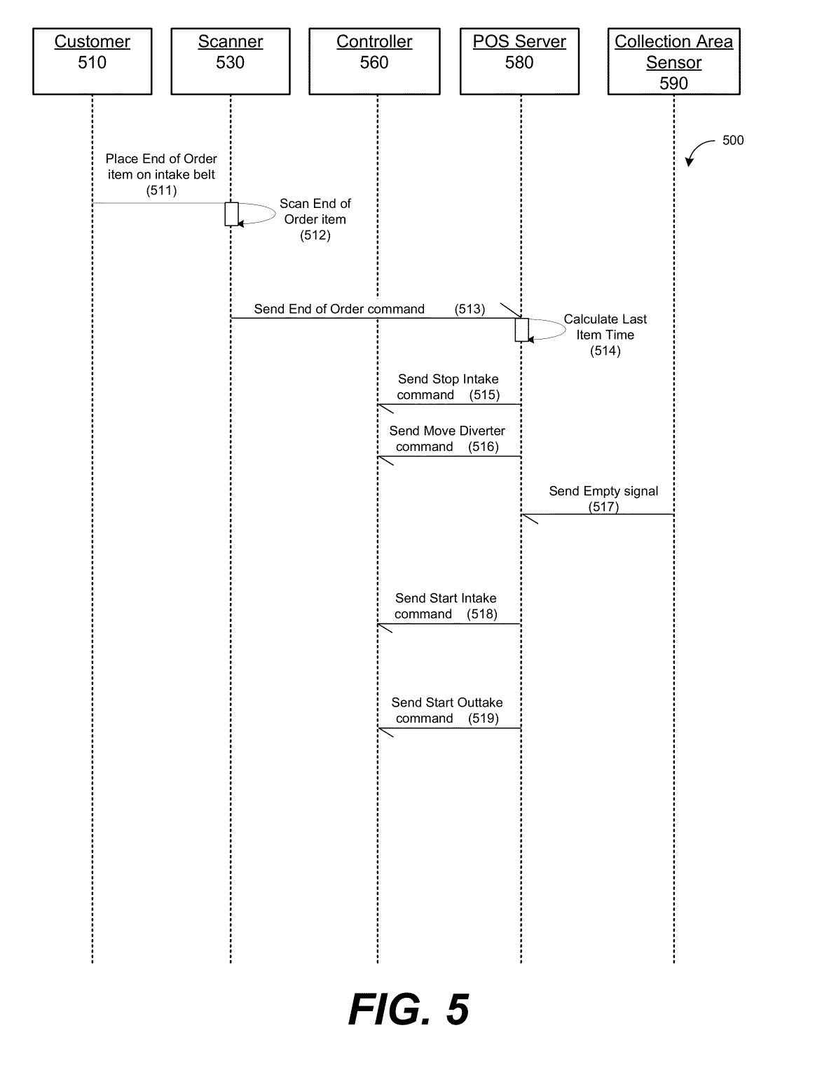

The checkout systems of the present disclosure may be configured to allow the POS server to control the movement and/or position of one or more moveable barriers or diverter arms (e.g., diverter arms 26 and 27 shown in FIG. 1) that direct the movement of items to one of several collection areas in the checkout stand in response to certain inputs or conditions detected in the system. These systems may, among other benefits, facilitate the separation of different customers' orders. One embodiment of a process 500 for controlling the motion of diverter arms 26 and 27 in the checkstand shown in FIG. 1 is shown in FIG. 5.

Referring now to FIG. 5, once all of a first customer's items have been scanned and directed to a collection area, an end-of-order divider placed on the intake conveyor after the last item (step 511) may be detected passing through the multi-item identification device (step 512). This event may correspond to step 251 in process 250 shown in FIG. 4. The multi-item identification device 530 will send a signal to the POS server 580 indicating that the end-of-order divider has been detected (step 513). Based on the speed of the conveyors on the checkstand (which may be communicated to the POS server via one or more sensors or a control mechanism on the conveyors themselves operatively connected to a controller and/or network switch), the POS server 580 calculates the time when the last item in the first customer's order will pass to the outtake conveyor (step 514). At that time, the POS server will send a signal to the controller 560 to stop the intake conveyor (step 515) and to move the divider arms to block the outtake conveyor corresponding to the collection area where the first customer's items were collected (516). which will direct any subsequently-scanned items onto outtake conveyor 28 (step 516). A sensor in a second collection area 590 sends a signal to the POS server 580 indicating whether items are present in that collection area (step 517). If the signal indicates that the second collection area is empty, the POS server 580 sends a signal to the controller 560 to start the intake conveyor (step 518), and optionally, a signal to start an outtake conveyor that conveys items to the second collection area (step 519). The checkstand will then begin scanning the next customer's items (e.g., according to processes 200 and 250 in FIGS. 3 and 4) and direct them to the second collection area.

In other embodiments, the POS server may control the position of one or more diverter arms to separate items for other reasons. For example, the POS server may send a signal to move a diverter arm to direct items to a second collection area when the first collection area is full (e.g., as detected by a sensor at the end of the outtake belt). In another embodiment, the POS server may send a signal to move a diverter arm when certain types of items (e.g., refrigerated or frozen items) are detected by the multi-item identification device. The diverter arm may direct those items to a separate collection area for bagging with similar types of items. Of course, a signal to move one or more diverter arms in a checkstand also may be sent to the POS sever by an attendant (e.g., via an attendant terminal at the checkstand) for any reason.

The checkout systems of the present disclosure may be configured to allow the POS server to control the operation of one or more lights, audio speakers, and/or other indicator or alert devices at specific locations in the retail store in response to certain inputs or conditions detected in the system. For example, if the POS server receives a signal from a sensor in an item collection area at a particular checkstand indicating an absence of items in that collection area, the POS server may send a signal to a controller that is operatively connected to an indicator light, display device, or audio speaker emitting a sound (either at that checkstand or at another location in the store) indicating that the checkstand is available for use. When a customer or attendant sees the light or display or hears the sound, they can proceed to the available checkstand instead of waiting in line at another checkstand. In some embodiments, a particular checkstand or location at the store may incorporate multiple different lights or displays connected to the controller, a speaker that is capable of emitting different sounds, or a display capable of displaying multiple different messages. The POS server may send different signals to the controller to activate each light, display, message, or sound individually, in order to communicate multiple different messages or pieces of information at a particular checkstand. This may, among other benefits, increase the efficiency with which the various checkstands at retail store are used and/or help move customers through checkout process more quickly.

4. Systems and Methods for Manning Exceptions

As previously mentioned, it is not uncommon for one or more exceptions to be generated during the itemization of a customer's order. For example, an exception may be generated where the multi-item identification device encounters defective or invalid information, or in response to the scanning of a particular type of item. An “exception” may include any instance in which an item is detected at the checkstand but is flagged for further action or review before adding it to the customer's order. Indeed, exceptions may occur in a variety of circumstances, including those situations where a multi-item identification device encounters defective or invalid information, or in response to identifying a particular type of item. For example, an exception can be generated when an item is mis-scanned, is not properly identified, requires age-verification for purchase, exceeds a pre-determined limit of items, may not be purchased at that time, etc. An exception also may be generated when multiple items and/or bar codes are identified simultaneously.

In embodiments of the present disclosure where an exception has been recorded in a customer's itemized order record, the exception may be resolved in a number of ways. For example, a terminal or display at the customer interaction station may prompt the customer to re-scan the item or may ask the customer to identify a mis-scanned item using an alternative method. In some embodiments, the checkout system of the present disclosure may require that the exception be resolved before adding further items to the order. In other embodiments, the exception may be allowed to persist for resolution at another time, either while the order is still active or following suspension and recalling of an otherwise completed order. An itemized order record for which the order has not been completed through payment, cancelled, or suspended for completion at a later time is considered an “active itemized order record”. In certain embodiments of the present disclosure, exceptions may be resolved by accessing an active itemized order record. For example, in certain embodiments, a customer may itemize their entire order including any exceptions, at which point the exceptions in the active itemized order record are accessed and resolved before further action is taken to complete the order, either by the customer himself (e.g., at a customer terminal) or by an attendant (e.g., at an attendant terminal) or other store personnel. In some embodiments, the attendant may access an active itemized order record to resolve one or more exceptions in the order from another terminal. In other embodiments, a customer may itemize their entire order, at which point the itemized order record may be suspended. The suspended itemized order record may be accessed (e.g., at another terminal) at a later time for exception resolution.

Furthermore, in certain embodiments, the present disclosure also provides systems and methods for resolving exceptions using a terminal or device other than the terminal or device at which the exception was generated. For example, an attendant or other store personnel may access an active order containing exceptions (e.g., via the attendant terminal or using a secondary input device such as a hand-held scanner, weight scale, etc., in parallel to the multi-item identification device), to resolve the exception. In other embodiments, once a customer has finished adding all their items to their order, the corresponding order including any exceptions may be suspended and subsequently recalled at another terminal, either by the customer or by store personnel, for exception resolution. The other terminal may be a customer terminal (other than the one where the order was itemized), an attendant terminal, another remote terminal in communication with the POS server, or a separate exception resolution terminal that can be operated by a customer, an attendant, or both.

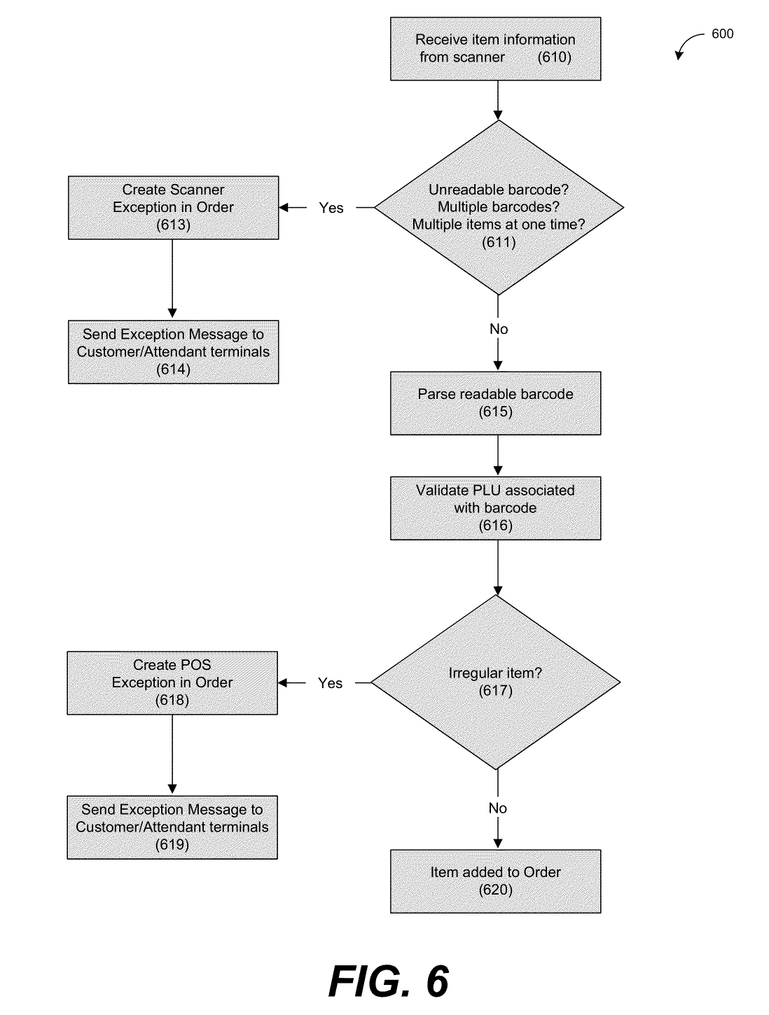

FIG. 6 depicts an embodiment of a process 600 for resolving exceptions in accordance with the present disclosure. In this embodiment, this process is run on the POS server. In step 610, the multi-item identification device sends item information (including images and bar codes) to the POS server (which corresponds to step 212 in FIG. 3). If the multi-item identification device sends information indicating an item with an unreadable barcode or multiple barcodes or the presence of multiple items being scanned at the same time (determined in step 611), the POS server creates a scanner exception in the order (step 613) and sends an exception message to a customer terminal and/or attendant terminal with an image of the item that was not scanned or had multiple barcodes (step 614). In some embodiments, the POS server may send a signal to the controller to activate a light, a speaker, or some other audiovisual component at the checkstand to indicate that an exception has occurred there (not shown).

The POS server also parses any barcode information from the multi-item identification device (step 615) and then validates the PLU number associated with each barcode (step 616). The POS server then determines whether any of the items scanned are irregular items as defined in the system (e.g., are zero-priced, age-restricted, require manager override, are not available for purchase at that time, etc.) (step 617). If not, no exception is generated, and the items are added to the order (step 620). If so, the POS server creates a POS exception in the order (step 618) associated with the item's information. The POS server then sends an exception message to a customer terminal and/or attendant terminal with an image of the item (step 619). In some embodiments, the POS server may send a signal to the controller to activate a light, a speaker, or some other audiovisual component at the checkstand to indicate that an exception has occurred there (not shown).

If exceptions have been created in an order, an attendant or customer may select an exception for resolution at any time while the order is still active by accessing the active order from a terminal, which may be a customer terminal where the order is being processed or another terminal operatively connected to the POS server. Once the exception is selected, the attendant or customer may resolve it in one of two ways. In some embodiments, the customer or attendant may choose to delete the exception. In this instance, the POS server removes the exception from the order and does not add the item to the order. If an item was not scanned properly or is not available for purchase, the attendant or customer may delete the exception and simply re-scan the excepted item to add it to the order. In some embodiments, it may be preferable to configure the POS server to only allow an attendant to manually delete exceptions, for example, to prevent a customers from taking items that were not added to his order.

Alternatively, an attendant or customer may resolve an exception by providing certain input needed to resolve the particular exception when it is created. For example, if the exception requires a manager override, the customer's age or birthdate (for age-restricted items), the POS server may prompt the customer or attendant at a terminal to provide the requisite input for the particular exception. Once the customer or attendant provides the input, the item will be added to the customer's order without the need to re-scan it.

When a customer or attendant provides input that all items in the order have been added or requesting that an order be completed, the POS server will determine whether any exceptions still exist in that order. If there are no exceptions in that order, then the POS server will proceed to the payment process. If a customer or attendant attempts to complete an order that contains exceptions, the POS server sends a message to the customer terminal or attendant terminal requesting that exceptions be cleared. At that point, the customer or attendant may resolve all of the exceptions in the order, or suspend the order for completion at another time and/or terminal.

In yet another embodiment, the present disclosure provides a method of retail checkout for resolving exceptions generated when multiple items or barcodes that are scanned simultaneously. In that embodiment, the checkout system may be configured to automatically (i.e., without further customer or attendant intervention) resolve the exception when the number of items and/or identification codes simultaneously identified by a multi-item identification device is larger than 1 but below a pre-determined threshold value. This may be particularly advantageous in the event that too many items are passed through the multi-item identification device simultaneously, which could ultimately result in a failure of the multi-item identification device to itemize all of the items. In some embodiments the pre-determined threshold value may be in the range of from about 3 to about 6.

As will be readily appreciated, suitable pre-determined threshold values may be adjusted based on a variety of factors including, but not limited to, the time of day, a range of the estimated number of items in the customer's order, the type of multi-item identification device, the speed of a conveyor belt carrying the items, etc. For example, in embodiments where a store clerk or other store personnel is operating the multi-item identification device, the pre-determined threshold value may be higher than for embodiments where the customer is operating the multi-item identification device, or it may be omitted completely.

The threshhold value for automatic exception resolution may be set in the software code running on a POS server or in a local software process run at a particular checkstand. In either embodiment, the threshhold value for automatic exception resolution for a particular checkstand may be varied from the threshhold value(s) for automatic exception resolution at other checkstand(s) in the same checkout system. The threshhold value for automatic exception resolution for a particular checkstand also may vary depending on the factors discussed below and/or any other factors apparent to a person of skill in the art with the benefit of this disclosure.

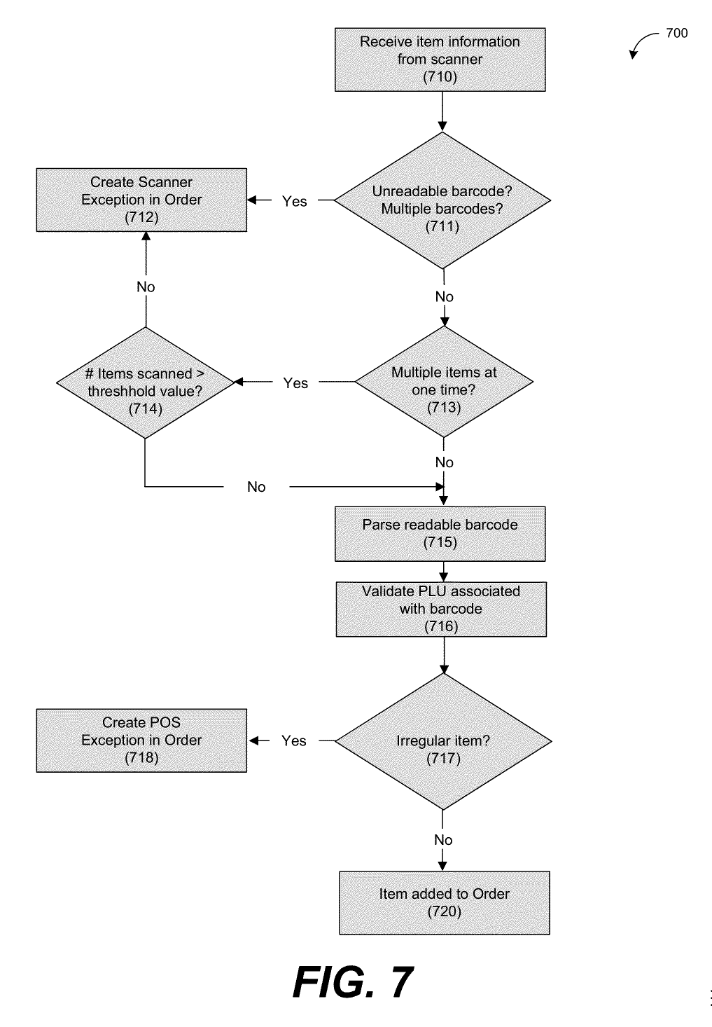

FIG. 7 depicts an embodiment of a process 700 for resolving exceptions in accordance with the present disclosure. Process 700 is similar to process 600 shown in FIG. 6 but is modified to automatically resolve certain exceptions created by the scanning of multiple items simultaneously. In process 700, if the multi-item identification device sends information indicating an item with an unreadable barcode or multiple barcodes (step 711), the POS server creates a scanner exception in the order (step 712) and sends an exception message to a customer terminal and/or attendant terminal with an image of the item that was not scanned or had multiple barcodes (not shown). If the multi-item identification device sends information indicating that multiple items were scanned at the same time (step 713), the POS server determines if the number of items scanned at the same time exceeds the predetermined threshhold value set for that particular multi-item identification device (step 714). If the number of items exceeds the predetermined threshhold value, the POS server creates a scanner exception in the order (step 712) and sends an exception message to a customer terminal and/or attendant terminal with an image of the items (not shown). If the number of items does not exceed the predetermined threshhold value, the POS server does not add an exception to the order, but instead proceeds to step 715 and the remaining steps in process 700, which are substantially similar to the corresponding steps in process 600.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A method of performing retail checkout comprising:
providing a multi-item identification device;
collecting identification data regarding each of a plurality of items using the multi-item identification device;
generating an active itemized order record that comprises information regarding each of the plurality of items using the identification data;
recording at least one exception record in the active itemized order record relating to one or more of the plurality of items;
providing a user with access to the active itemized order record; and
using input from the user to resolve the exception record in the active itemized order record.

2. The method of claim 1 wherein:
collecting identification data regarding each of a plurality of items using the multi-item identification device further comprises collecting identification data regarding at least one item having an unreadable barcode; and
the at least one exception record relates to the one or more items having an unreadable barcode.

3. The method of claim 1 wherein:
collecting identification data regarding each of a plurality of items using the multi-item identification device further comprises collecting identification data regarding at least one item having multiple barcodes; and
the at least one exception record relates to the one or more items having multiple barcodes.

4. The method of claim 1 wherein:
collecting identification data regarding each of a plurality of items using the multi-item identification device further comprises scanning one or more items that require age verification for purchase; and
the at least one exception record relates to the one or more items that require age verification for purchase.

5. The method of claim 1 further comprising the step of collecting identification data regarding at least one additional item using the multi-item identification device while the active itemized order record is accessed by the user to resolve an exception record.

6. The method of claim 1 wherein the user is a store attendant.

7. The method of claim 1 wherein the user is a customer.

8. The method of claim 1 wherein the multi-item identification device comprises a multi-item scanner.

9. The method of claim 1 further comprising adding at least one item relating to an exception record in the active itemized order record after the step of resolving the exception record without re-scanning the item.

10. A method of performing retail checkout comprising:
providing a multi-item identification device;
collecting identification data regarding each of a plurality of items using the multi-item identification device;
generating an active itemized order record that comprises information regarding each of the plurality of items using the identification data;
recording at least one exception record in the active itemized order record relating to one or more of the plurality of items;
suspending the active itemized order record at a first terminal to generate a suspended itemized order record comprising at least one exception record;
providing a user with access to the suspended itemized order record; and
using input from the user to resolve the exception record in the suspended itemized order record.

11. The method of claim 10 further comprising adding at least one item relating to an exception record in the active itemized order record after the step of resolving the exception record without re-scanning the item.

12. A computer program stored in a tangible medium for performing a retail checkout process comprising a plurality of instructions that when executed cause at least one processor to:
receive identification data regarding each of a plurality of items from a multi-item identification device;
generate an active itemized order record that comprises information regarding each of the plurality of items using the identification data;
record at least one exception record in the active itemized order record relating to one or more of the plurality of items;
provide an active itemized order record to a user; and
receive input from the user to resolve the exception record in the active itemized order record.

13. The computer program of claim 12 wherein the plurality of instructions when executed further cause the at least one processor to receive identification data regarding at least one additional item from the multi-item identification device while the processor is providing an active itemized order to a user.

14. The computer program of claim 12 wherein the multi-item identification device comprises a multi-item scanner.

15. The computer program of claim 12 wherein the plurality of instructions when executed further cause the at least one processor to add at least one item relating to an exception record in the active itemized order record after resolving the exception record without re-scanning the item.

16. A method of performing retail checkout comprising:
providing a multi-item identification device;
scanning or imaging each of a plurality of items using the multi-item identification device, wherein two or more of the plurality of items are scanned or imaged substantially simultaneously;
generating an active itemized order record that comprises information regarding each of the plurality of items; and
recording at least one exception record in the active itemized order record relating to the items that are scanned or imaged substantially simultaneously if the number of items scanned or imaged by the multi-item identification device substantially simultaneously exceeds a pre-determined threshhold value.

17. The method of claim 16 wherein the pre-determined threshhold value is from about 3 to about 6.

18. A retail checkout system comprising:
one or more checkstands that each comprise
a multi-item identification device configured to collect identification data regarding items in a customer's order, and
an interface unit configured to transmit data to a data server based at least in part on the item identification data collected by the multi-item identification device; and
a data server that comprises
at least one processor,
an interface unit configured to receive data from one or more checkstands, and
a memory comprising executable instructions that, when executed, cause the at least one processor to:
generate itemized order records that comprise information regarding the items in a customer's order,
record exception records in an itemized order record relating to one or more items in the customer's order, and
resolve an exception record in an itemized order record in response to input from a user.

19. The retail checkout system of claim 18 wherein the data server is further configured to add at least one item relating to exception record in the itemized order record after resolving the exception record without requiring that the item be re-scanned.

20. The retail checkout system of claim 18 wherein:
the retail checkout system further comprises a controller configured to activate an audiovisual component, the controller comprising an interface unit configured to receive signals from the data server; and
the executable instructions, when executed, also cause the at least one processor to send a signal to the controller to activate the audiovisual component when an exception record is recorded.
